(19) United States
(12) Patent Application Publication
(10) Pub. No.: US 2023/0021586 A1
(43) Pub. Date: Jan. 26, 2023

(54) INDUCTIVE COOKTOP DISPLAY

(71) Applicant: GHSP, Inc., Holland, MI (US)

(72) Inventors: Cort Corwin, Grand Haven, MI (US); Andrew Foley, Holland, MI (US); Warren Gutherie, West Olive, MI (US); John Videtich, Zeeland, MI (US)

(21) Appl. No.: 17/758,502

(22) PCT Filed: Jan. 7, 2021
(86) PCT No.: PCT/US2021/012488

§ 371 Date: Jul. 7, 2022

Related U.S. Application Data
(60) Provisional application No. 62/958,078, filed on Jan. 7, 2020.

(51) Int. Cl. F24C 7/08; H05B 6/12

(52) U.S. Cl. CPC F24C 7/083; H05B 6/1218

(57) ABSTRACT

A system for improving a display coupled to an inductive cooktop includes an induction coil and an electrically-actuated display (EAD) assembly. The induction coil includes a magnetic field. The EAD assembly is disposed on the induction coil and includes a frontplate adjacent to the induction coil and a thin film transistor (TFT) array backplane opposite the frontplane. The TFT array backplane includes a scan line with some degree of orthogonality to the magnetic field and a data line with some degree of parallelism to the magnetic field. The scan line and the data line are configured to activate a display pixel corresponding to the EAD assembly. One or more ground lines of the EAD assembly have some degree of parallelism to the magnetic field of the induction coil.

### CROSS-REFERENCE TO RELATED APPLICATION

This application claims priority under 35 U.S.C § 119(e) to U.S. Provisional Patent Application No. 62/958,078, filed Jan. 7, 2020, the disclosure of this prior application is considered part of this application and is hereby incorporated by reference in its entirety.

### TECHNICAL FIELD

This disclosure relates to an inductive cooktop display.

### BACKGROUND

Kitchens or other areas used to prepare and cook food may have an inductive cooktop, such as a cooktop that is part of a range unit or a separate cooktop unit that is placed on or installed directly in a countertop or other work surface. It is known that inductive cooktops can be used to effectively heat metal cookware that is capable of inductively coupling with an electromagnetic field generated by the cooktop.

It is common for inductive cooktops to have a top panel that supports cookware on the cooktop, such that during use, the top panel often is conductively heated by the inductively heated cookware. The residual heat at the top surface of the top panel is often dangerous to touch and is difficult and sometime unable to be visibly recognized. Presently known measures to indicate a hot top surface are provide by a lights adjacent to the hot area or with messages displayed on relatively small display screens at the front edge of the cooktop, which is frequently located away from the hot area of the top surface.

Attempts to incorporate displays or other electronics near to or overlapping the hot areas of the top panel can encounter several issues, such as those related the heat's negative affect on the operation of the display electronics and issue related to the magnetic fields generated by the induction coils interfering with operation of the display and other electronics.

### SUMMARY

These and other needs are met by the present disclosure, which presents a system including an induction coil and an electrically-actuated display (EAD) assembly. The induction coil includes a magnetic field. The EAD assembly is disposed on the induction coil and includes a frontplate adjacent to the induction coil and a thin film transistor (TFT) array backplane opposite the frontplane. The TFT array backplane includes a scan line orthogonal to the magnetic field and a data line parallel to the magnetic field. The scan line and the data line are configured to activate a display pixel corresponding to the EAD assembly. One or more ground lines of the EAD assembly are arranged parallel to the magnetic field of the induction coil. In some examples, the frontplane includes a passivation layer encapsulating a portion of the EAD assembly where the passivation layer includes at least one of the one or more ground lines of the EAD assembly. In some implementations, the frontplane does not include a metal encapsulation layer configured to function as a ground plane for the EAD assembly. In some configurations, all of the ground lines of the EAD assembly are arranged parallel to the magnetic field of the induction coil. The EAD assembly may be disposed on and offset from the induction coil by an air gap. The induction coil may be a C-shaped solenoid coil. The EAD assembly may include an organic light emitting diode (OLED).

Another aspect is a system that includes a switch circuit, a drive circuit, and a controller. The switch circuit is configured to activate a pixel for an electrically-actuated display (EAD). The drive circuit includes a light-emitting element (LEE) and powers the LEE when the switch circuit activates the pixel. The controller controls the switch circuit and is configured to perform operations. The operations include generating a scan signal and a data signal, reducing crosstalk interference between the scan signal and an adjacent induction coil, and activating the pixel corresponding to the switch circuit using the amplified scan signal and the data signal. The operation reduces crosstalk interference between the scan signal and an adjacent induction coil by splitting the scan signal into a first scan signal and a second scan signal and differentially amplifying the first scan signal and the second scan signal to form an amplified scan signal. Here, the second scan signal is complimentary to the first scan signal. In some examples, the operations further include reducing crosstalk interference between the data signal and the adjacent induction coil by splitting the data signal into a first data signal and a second data signal where the second data signal complimentary to the first data signal and wherein activating the pixel corresponding to the switch circuit uses the amplified scan signal, the first data signal, and the second data signal. In these examples, the operations may include differentially amplifying the first data signal and the second data signal to form an amplified data signal and wherein activating the pixel corresponding to the switch circuit uses the amplified scan signal and the amplified data signal. In some implementations, the operations also include applying the second data signal to the drive circuit where the second data signal functions as a ground for the drive circuit. The EAD assembly may be disposed on and offset from the induction coil by an air gap. The induction coil may be a C-shaped solenoid coil. The LEE may be an organic light emitting diode (OLED).

In yet another aspect of the disclosure, a system includes a switch circuit, a drive circuit, and a controller. The switch circuit is configured to activate a pixel for an electrically-actuated display (EAD). The drive circuit includes a light-emitting element (LEE) and powers the LEE when the switch circuit activates the pixel. The controller controls the switch circuit and is configured to perform operations. The operations include generating a scan signal and a data signal, reducing crosstalk interference between the data signal and an adjacent induction coil, and activating the pixel corresponding to the switch circuit using a first data signal, a second data signal, and the scan signal. The operations reduce crosstalk interference between the data signal and an adjacent induction coil by splitting the data signal into the first data signal and the second data signal. The second data signal is complimentary to the first data signal. In some examples, the operations further include differentially amplifying the first data signal and the second data signal to form an amplified data signal and activating the pixel corresponding to the switch circuit using the scan signal and the amplified data signal. In these examples, the operations may also include applying the second data signal to the drive circuit where the second data signal functions as a ground for the drive circuit. The induction coil may be a C-shaped solenoid coil. The LEE may be an organic light emitting diode (OLED).

Another aspect of the disclosure provides a pixel circuit that includes a switch circuit and a drive circuit. The switch circuit is configured to activate a pixel for an electrically-actuated display and includes at least one transistor. The drive circuit includes a light-emitting element (LEE) and powers the LEE when the switch circuit activates the pixel. At least one of the at least one transistor or the LEE includes a doping profile based on a magnetic field generated by an induction coil adjacent to the pixel circuit. The doping profile is configured to generate an activation voltage for the at least one of the at least one transistor or the LEE that reduces interference at the pixel circuit. In some implementations, the doping profile reduces interference between the magnetic field generated by the induction coil and one or more signals communicated to the pixel circuit. In some examples, the at least one transistor includes a first transistor and a second transistor where the first transistor is activated by a scan signal from a controller in communication with the switch circuit and the second transistor is activated by a data signal when the first transistor is activated. Here, the activation of the second transistor enables the drive circuit to power the LEE. The first transistor may include the doping profile based on the magnetic field generated by the induction coil while the second transistor may not include the doping profile based on the magnetic field generated by the induction coil. Oppositely, the second transistor may include the doping profile based on the magnetic field generated by the induction coil while the first transistor may not include the doping profile based on the magnetic field generated by the induction coil. The LEE of the drive circuit may include the doping profile based on the magnetic field. Both of the LEE of the drive circuit and the at least one transistor may include the doping profile. When both include the doping profile, the LEE may include a LEE doping profile while the at least one transistor includes a transistor doping profile. The LEE doping profile may be different from the transistor doping profile. The induction coil may be a C-shaped solenoid coil. The LEE may be an organic light emitting diode (OLED).

Another aspect of the disclosure provides an induction coil having a magnetic field, a pixel circuit disposed on the induction coil, and a controller controlling the pixel circuit. The pixel circuit includes a switch circuit and a drive circuit. The switch circuit is configured to activate a pixel for an electrically-actuated display (EAD). The drive circuit includes a light-emitting element (LEE) and powers the LEE when the switch circuit activates the pixel. The controller is configured to perform operations comprising overdriving the LEE to reduce visible interference in the LEE display during operation of the induction coil. In some examples, the controller controls a plurality of pixel circuits, the plurality of pixel circuits corresponding to a grouping of adjacent pixels. The induction coil may be a C-shaped solenoid coil. The LEE may be an organic light emitting diode (OLED).

Yet another aspect of the disclosure provides a pixel circuit that includes a switch circuit and a drive circuit. The switch circuit is configured to activate a pixel for an electrically-actuated display and includes at least one transistor and a narrow band notch filter. The drive circuit includes a light-emitting element (LEE) and powers the LEE when the switch circuit activates the pixel. The narrow band notch filter filters a frequency generated by an induction coil adjacent to the pixel circuit when the frequency generated by the induction coil is greater than a frequency associated with a data signal provided to the switch circuit by a pixel circuit controller. The induction coil may be a C-shaped solenoid coil. The LEE may be an organic light emitting diode (OLED).

An additional aspect of the disclosure provides a system that includes an induction coil having a magnetic field, a pixel circuit disposed on the induction coil, and a controller controlling the pixel circuit and the induction coil. The pixel circuit includes a switch circuit and a drive circuit. The switch circuit is configured to activate a pixel for an electrically-actuated display. The drive circuit includes a light-emitting element (LEE) and powers the LEE when the switch circuit activates the pixel. The controller is configured to activate a scan signal for the pixel circuit when an induced voltage from the magnetic field of the induction coil is equal to zero for the pixel. The controlled may include a first controller for controlling the pixel circuit and a second controller (e.g., a second controller separate from the first controller) for controller the induction coil. The induction coil may be a C-shaped solenoid coil. The LEE may be an organic light emitting diode (OLED).

The details of one or more implementations of the disclosure are set forth in the accompanying drawings and the description below. Other aspects, advantages, purposes, and features will be apparent upon review of the following specification in conjunction with the drawings.

### DESCRIPTION OF DRAWINGS

FIG. 1A is a perspective view of an example countertop with an inductive cooktop.

FIG. 1B is a perspective view of an example disc-shaped induction coil disposed below a pan resting on an inductive cooktop.

FIG. 1C is a schematic view of an example magnetic field generated by the induction coil shown in FIG. 1B.

FIG. 1D is a schematic view of an example of a stack of layers corresponding to the inductive cooktop of FIG. 1A.

FIG. 1E is a schematic view of an example of a stack of layers corresponding to an organic light emitting diode (OLED) display for the inductive cooktop of FIG. 1A.

FIG. 2A is a schematic view of an example pixel circuit for an OLED display.

FIG. 2B is a top view of an example arrangement of signal lines for an OLED display.

FIGS. 2C-2G are schematic views of example pixel circuits for an OLED display.

FIG. 3 is a schematic view of an example computing device that may be used to implement the systems and methods described herein.

Like reference symbols in the various drawings indicate like elements.

### DETAILED DESCRIPTION

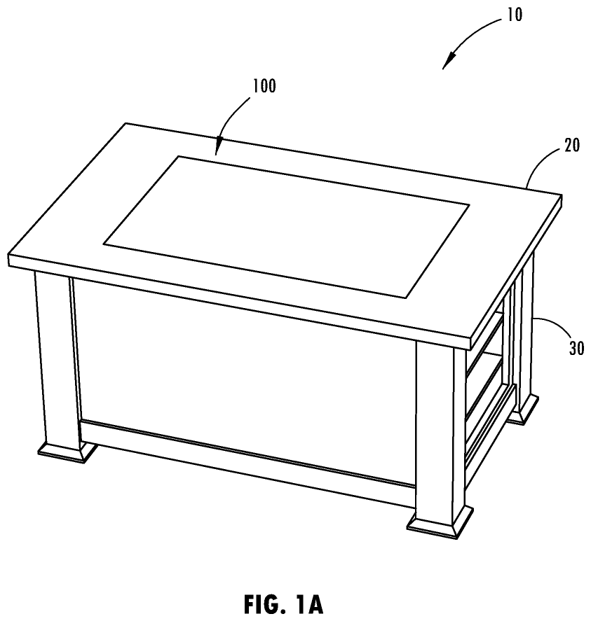

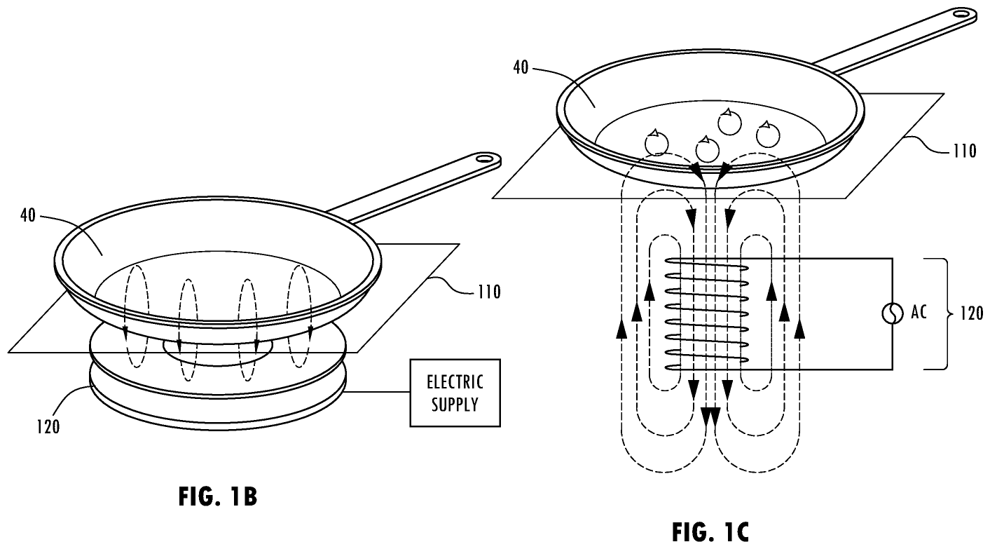

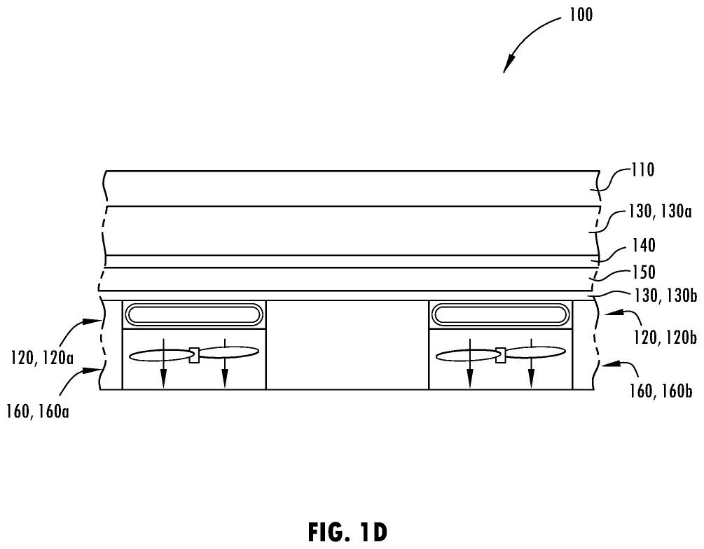

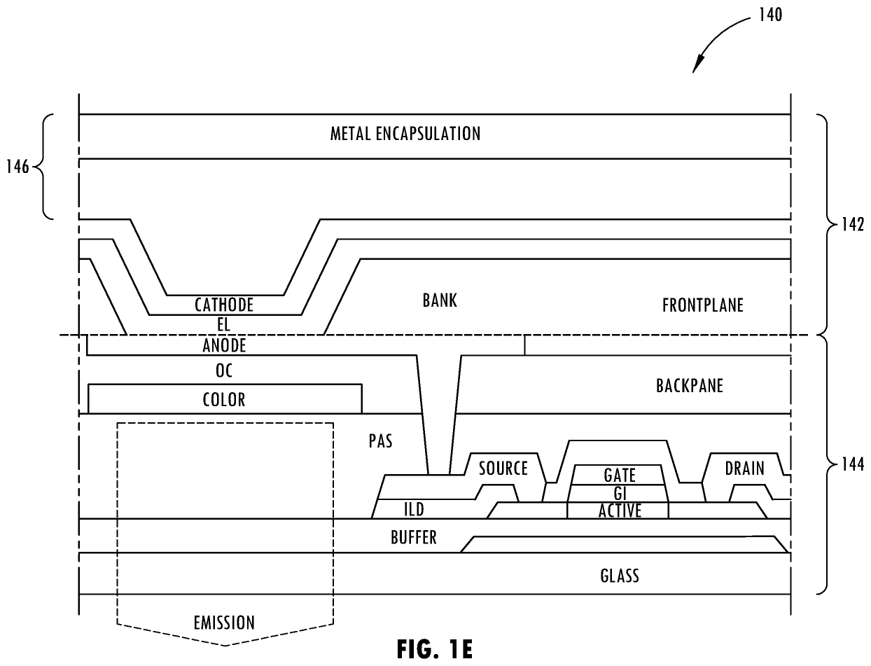

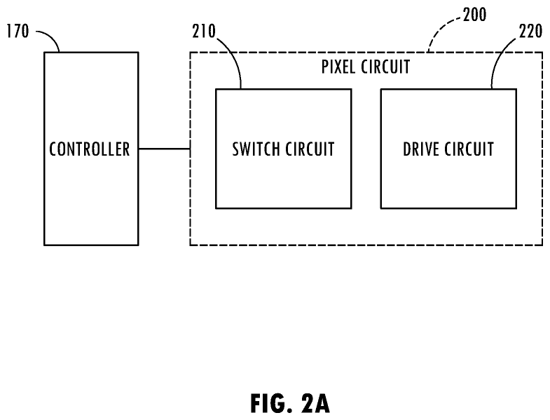

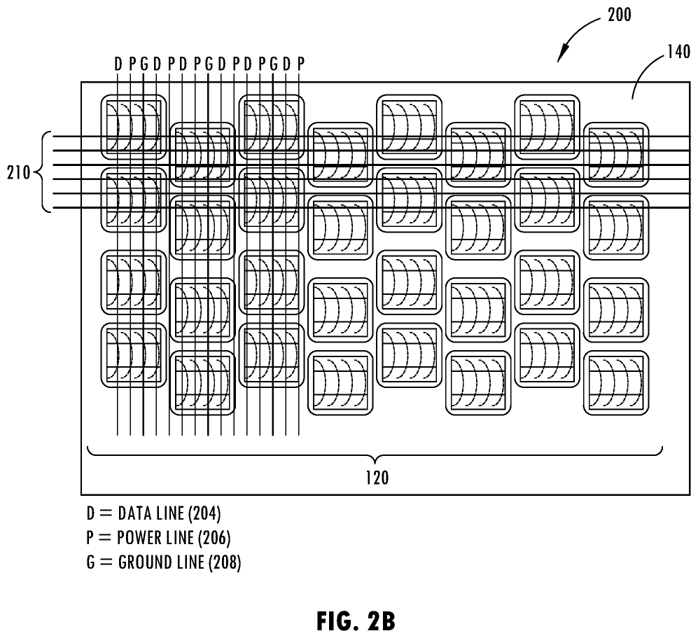

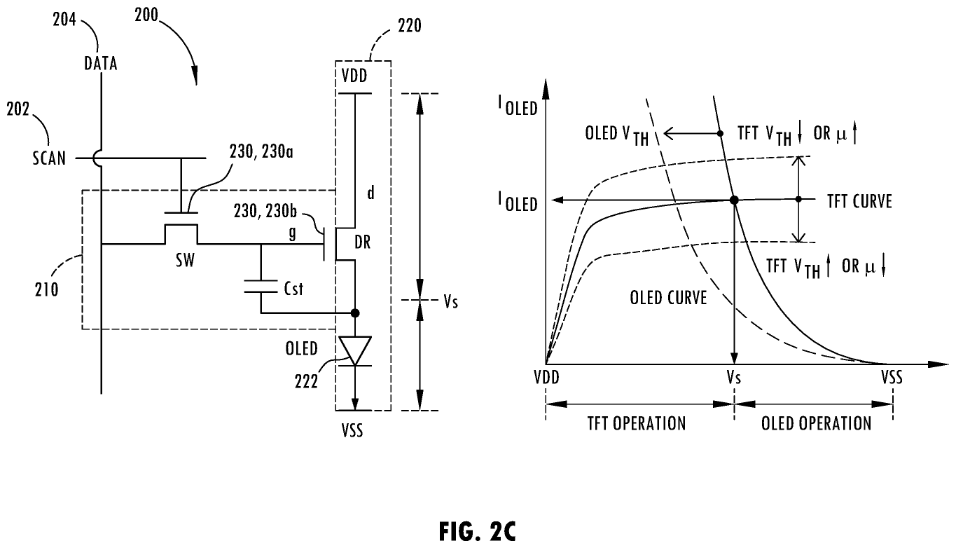

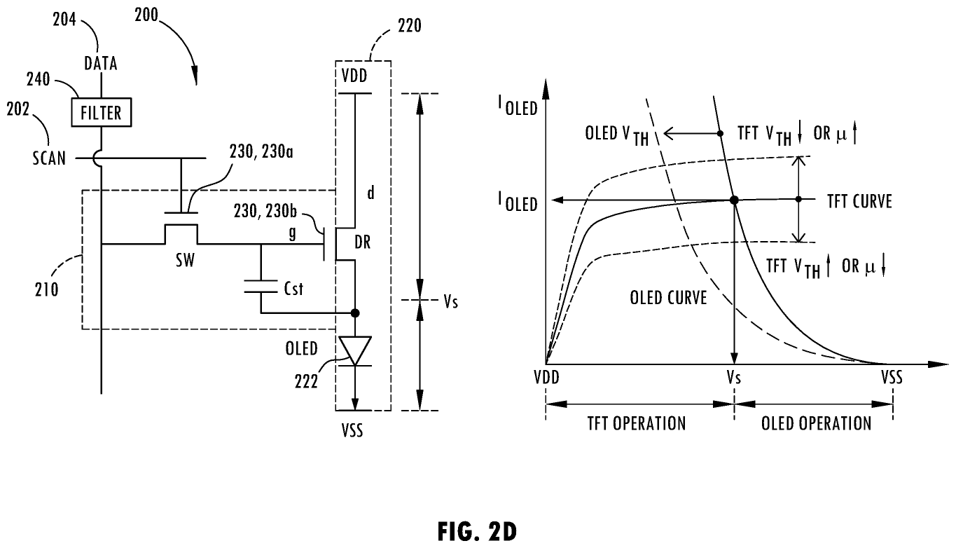

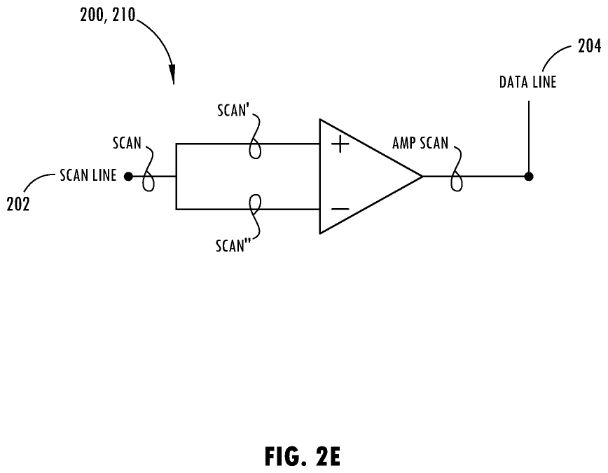

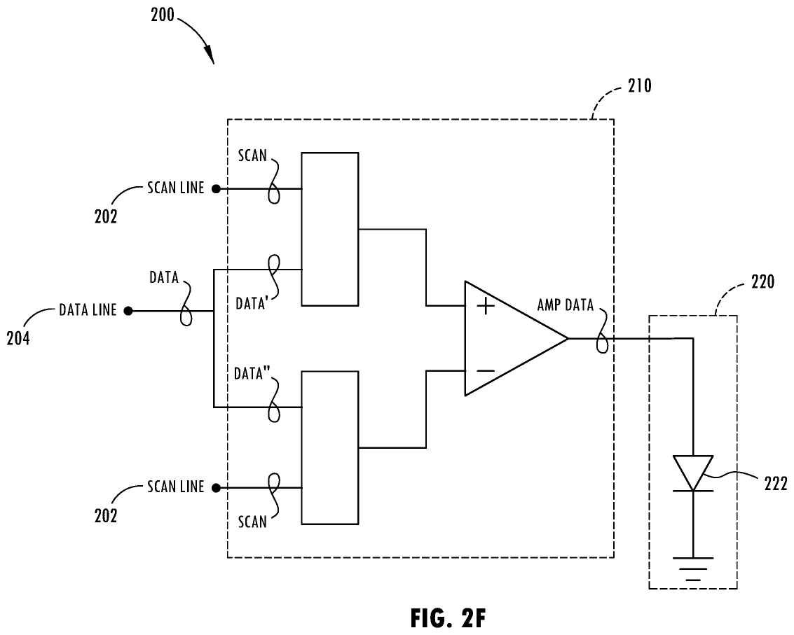

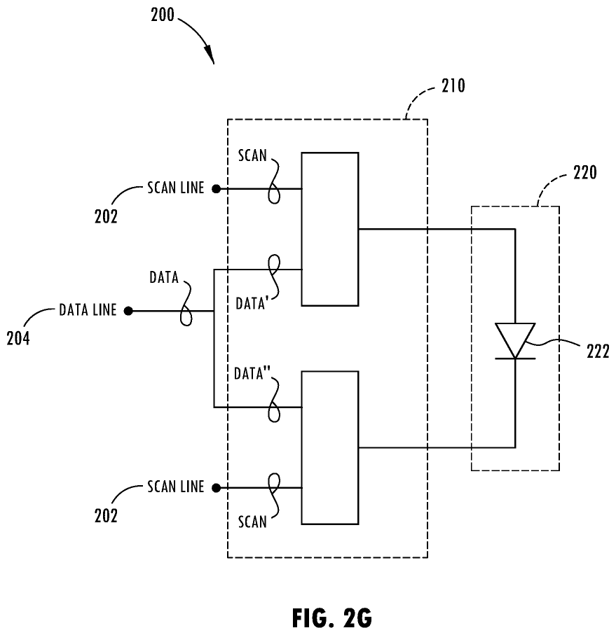

Referring to FIG. 1A, in some implementations, an inductive cooktop system 100 is provided in a kitchen environment 10 or other area used to prepare and/or cook food. For example, FIG. 1A illustrates the inductive cooktop system 100 installed in a countertop 20 of a cabinet 30 within the kitchen environment (e.g., a kitchen island). As shown in FIGS. 1B and 1C, the inductive cooktop system 100 includes a top plate 110 (e.g., a ceramic cooktop) and an induction coil 120 (e.g., a solenoid coil) that is disposed below the top plate 110. Here, the inductive coil 120 may refer to a coil of various shapes or configurations where the coil is wrapped around a magnetic core (e.g., a ferromagnetic material). These configurations may range from a C-shaped (or C-type) coil where each end of the “C” is adjacent to the top plate 110 to a more traditional pancake coil (also known as an Archimedes coil). The inductive coil 120 (or simply coil 120) may refer to a single coil or a plurality of coils (e.g., shown as an array of coils in FIG. 2B) below the top plate 110 (also referred to as a cooktop surface 110).

A power supply may supply alternating current, such as high-frequency or medium-frequency current, to the induction coil 120 to create an electromagnetic field that can inductively couple with and heat a cookware object 40 (e.g., a pan) supported on an upper surface of the top plate 110. The electromagnetic field may permeate through the upper surface of the top plate 110 in the area immediately above the induction coil 120. The electromagnetic field oscillates to create eddy currents in or near the bottom portion of the cookware object 40 that is supported on the top plate 110, such that the resistance of the cookware object 40 to the eddy currents causes resistive heating of the cookware object 40. Thus, the inductively heated cookware object 40 may heat and cook the contents within the cookware object 40. To adjust cooking settings, such as temperature, the current supplied to the induction coil 120 may be adjusted.

The cookware object 40 may include a ferrous metal, such as at least at a base of the cookware, to be capable of inductively coupling with the induction coil 120 and conductively spreading the heat to the cooking surface within the object 40. Also, the cookware object 40 may include various types of cooking vessels, such as a pot, a pan, an induction plate, a wok, and the like. It is also contemplated that the cookware object 40 may be product packaging, such as a metal food packaging that is configured to be used without an underlying piece of cookware. Further, it is contemplated that the object 40 may be an electrical device that is configured to inductively couple with the inductive coil 120 to transfer data or power via the inductive coupling. Such an electrical device may include a small kitchen appliance, such as a toaster or blender, a receptacle unit for plugging in other devices powered via electrical wires, or other personal electronic devices, such as cell phones.

Referring to FIG. 1D, in some examples, the inductive cooktop system 100 includes one or more dissipation layers 130 and an electrically-actuated display 140 (also referred to as the display 140) between the cooktop surface 110 and the inductive coil 120 (also referred to as a coil layer 120). Here, a dissipation layer 130 may act as a thermal insulator such that heat generated by the coil layer 120, the display 140, and/or the cooktop surface 110 (e.g., via the cookware object 40) may be dissipated during operation of the cooktop system 100. This dissipation may help prevent malfunction and/or failure of different layers of the system 100, such as the display layer 140. A dissipation layer 130 may be a thermal insulating material or an air gap that allows air to flow between the layers. Although the system 100 of FIG. 1D illustrates two dissipation layers 130, 130a-b (e.g., a first dissipation layer 130a between the cooktop surface 110 and the display 140 and a second dissipation layer 130b between the display 140 and the coil layer 120), the system 100 may include any number of dissipation layers 130. In some examples, in order to maintain the position of each layer, one or more layers of the system 100 may have structural standoffs. Additionally or alternatively, the system 100 or portions thereof may be fixed in position by a frame structure corresponding to the system 100.

Beneath the display 140, a support layer 150 (e.g., a glass support layer) provides a non-conducting support for the display 140. Below the support layer 150, a second dissipation layer 130b is shown separating the display 140 from the coil layer 120 (e.g., shown as two coils, 120, 120a-b). Beneath the coil layer 120, the system 100 may additionally include a cooling layer 160. For instance, each coil 120a-b includes a downdraft fan 160, 160a-b that functions to draw heat downward and away from the layers above the coil layer 120 (e.g., the display 140 or the cooktop surface 110).

In some examples, the display 140 generally operates by coordinating the emission of light to generate graphics or other content information. For instance, based on this operation, a user perceives the emission of light as a display projected on the cooktop surface 110. In some implementations, the display 140 corresponds to a light-emitting display such as a light-emitting diode (LED) or organic light emitting diode (OLED) display. For example, an OLED display 140 emits light using one or more OLEDs. Unfortunately, to use some types of displays 140, such as OLED displays, in conjunction with an inductive coil layer 120, the system 100 needs to ensure that the display 140 functions in particular operating conditions. For instance, the operation of the display 140 (e.g., an OLED display) may be diminished or compromised if the display 140 is subjected to too much heat or too much electrical interference from a magnetic field associated with the coil layer 120.

Referring to FIG. 1D, one or more dissipation layers 130 may function to dissipate heat from a hot object resting on the cooktop surface 110. In some examples, in order to properly dissipate heat, the display 140 may be offset from the cooktop surface 110 by a threshold distance. For instance, the first dissipation layer 130a has a thickness that is greater than or equal to the threshold distance to provide a space for sufficient insulation to prevent a hot object (e.g., the cookware object 40) resting on the cooktop surface 110 from damaging the display 140. In some implementations, the threshold distance may depend upon the type(s) and/or density of insulation used in the space. Additionally, the dissipation layer 130 may have transparent properties (e.g., optical clarity) to prevent blurring or otherwise distorting the image quality of the display 140, such that the insulation may be referenced as a transparent thermal insulator. The transparent thermal insulator may be a gas, liquid, or solid state insulation. In the case of gas or liquid, the insulating material may also flow through the space being heated to remove heat being transferred to the corresponding insulating material. The transparent thermal insulator may also be a silica aerogel material that is disposed at one or more locations between an upper display surface of the display 140 and the upper surface of the top plate 110. The transparent thermal insulator may be integrated with the top plate 110 or may be disposed between the top plate 110 and display 140, such that the top plate 110 may be a homogenous panel (e.g., a glass panel).

In an OLED display 140, the LEDs include a film of organic compound that emit light in response to an electric current. Because the LEDs emit visible light, a backlight is not needed. This helps allow the display to be thin, and in some examples, partially transparent. In some implementations, the display 140 includes a plurality of pixels such that each pixel of the display 140 corresponds to an OLED. In some configurations, each pixel of the display 140 may be subdivided to include a red sub-pixel, a green-sub pixel, a blue sub-pixel, and/or a white sub-pixel. Referring to FIG. 1E, the display 140 includes into a frontplane 142 and a backplane 144. Here, the frontplane 142 generally faces, and is adjacent to, the support layer 150 and/or coil layer 120, while the backplane 144 faces the cooktop surface 110 such that an emission of light at a particular pixel projects outward towards the cooktop surface 110 to be perceived by a user within the kitchen environment 10. In some examples, the frontplane 142 includes organic compound layers sandwiched between a cathode and an anode. In some implementations, the frontplane 142 also includes a passivation layer 146 that functions to prevent oxidation or other foreign matter ingress to layers within the frontplane 142 and/or backplane 144. In some examples, the passivation layer 146 includes a metal encapsulation layer (e.g., a stainless steel foil or thin film conductor layer) that functions as a ground plane for the circuitry of the display 140. When the passivation layer 146 includes the metal encapsulation layer, the metal encapsulation layer may help focus light towards the cooktop surface 110 using the reflective properties of the metal.

As shown in FIG. 1E, in some examples, the backplane 144 is a thin film transistor (TFT) array. For instance, a circuit that corresponds to each pixel of the display 140 (i.e., a pixel circuit) includes a transistor that is configured to activate a pixel and a transistor that enables a power source (e.g., voltage source or a current source) to drive an OLED corresponding to the pixel. The transistors of the TFT array may be field effect transistors (FETs) such that each transistor includes a gate (g), a drain (d), and a source (s) where the gate (g) functions as a switch to permit electron flow between the drain d and the source s.

In some implementations, such as FIG. 2A, the inductive cooktop 100 additionally includes a controller 170, such as control system circuitry, that is coupled with and in communication with the coil layer 120 and the display 140. Here, the controller 170 is configured to control the display 140, such as to display information at the cooktop surface 110, including at an area or areas of the upper surface that interfaces with a cookware object 40 that is inductively coupled with an induction coil 120. The controller 170 may control information displayed by the display 140 before, during, or after operation of the induction coil 120 inductively coupling with a cookware object 40. Some information displayed by the display 140 may include operational information of the cooktop, outlines of cooking zones or control interfaces, control interface images, media widows or information, or branding or advertising windows or information and other conceivable images and graphics. In some configurations, the controller 170 refers to one or more controllers. For instance, a first controller 170 controls the display 140 while a second controller 170 controls the coil layer 120.

Referring further to FIG. 2A, to control the display 140, the controller 170 is configured to control individual pixels of the display 140 by interfacing with and controlling voltage, current, and/or other signals to a pixel circuit 200. The pixel circuit 200 generally includes a switch circuit 210 configured to activate a given pixel within the display 140 and a drive circuit 220 that includes a light-emitting electrical element (e.g., an OLED) corresponding to the given pixel. Here, the drive circuit 220 powers the light-emitting electrical element when the switch circuit 210 becomes active for the given pixel. Each pixel circuit 200 corresponding to a light-emitting electrical element (e.g., an OLED) for a pixel is controlled by at least one scan line 202 and at least one data line 204. The scan line 202 may activate or enable rows of pixels (i.e., OLEDs) along the display 140 sequentially while the data line 204 may provide the appropriate voltage or current to enable the drive circuit 220 to drive the light-emitting electrical element (i.e., illuminate the OLED) of the pixel circuit 200. The data line 204 may provide the drive voltage or drive current for the light-emitting electrical element (e.g., the OLED) or an additional power/current source (e.g., another feature of the controller 170) may power the light-emitting electrical element (e.g., the OLED). In some examples, the TFT array backplane 144 associated with the pixel circuit 200 includes one or more scan lines 202 and one or more data lines 204 to activate one or more transistors within the TFT array of the backplane 144.

When a coil 120 is active, the active coil 120 generates a magnetic field. Due to this magnetic field, an active coil may additionally generates an induced voltage affecting conductive material within a given range of the magnetic field. In other words, conductive traces, wires, lines, or planes that are adjacent to an active coil 120 are susceptible to interference caused by the induced voltage. Due to the adjacency between the display 140 and the coil layer 120, components of the display 140 (e.g., the OLEDs) may be susceptible to such interference. More particularly, signal lines such as scan lines 202, data lines 204, power lines 206, and/or ground lines 208, of a pixel circuit 200 within a display 140 may be susceptible to interference caused by the magnetic field of one or more coils 120. This is especially true, even for signals less sensitive to interference, when the power of a magnetic field is increased (e.g., when a user turns up the power on a coil 120 to increase the cooking power at the cookware object 40). As an example, the data line 204 is linked to the control of the intensity of the OLED via the voltage or current applied to a gate g of a transistor that activates a drive circuit 220 (FIG. 2C). Thus, voltage coupled onto the data line 204 (e.g., induced voltage from the magnetic field of the coil 120) may result in the OLED emitting an incorrect amount of light (e.g., more or less light than expected). In some examples, coupled noise may cause light-emitting electrical elements (e.g., OLEDs) that should remain dark to emit light. This effect is particularly detrimental when a display 140 attempts to generate content at or near a cooking area where a coil 120 is active.

To address some of the potential interference (e.g., in or adjacent to active cooking areas), the signal lines of a pixel circuit 200 (or a plurality of pixel circuits 200 of the OLED display 140) may be configured to reduce interference or cross talk noise. Referring to FIG. 2B, each coil 120 of the coil layer 120 may corresponds to a C-type solenoid coil. As an induction coil 120, the coils 120 generate a magnetic field with some degree of orthogonality to the scan lines 202 illustrated in FIG. 2B. For instance, a C-type solenoid coil 120 generates a magnetic field that is generally orthogonal to the scan lines 202. Here, “generally” orthogonal means that the scan lines and magnetic field are usually orthogonal, but may some degree of deviation from an absolute ninety-degree relationship. Although it may be theoretically optimal to orient all lines susceptible to interference parallel to the magnetic field to prevent interference from induced voltage, the display 140 may not be afforded that luxury. As such, FIG. 2B depicts an orientation where the scan lines 202 of one or more pixel circuits 200 are oriented orthogonal to the magnetic field of the coil layer 120 and the data lines 204, power lines 206, and the ground lines 208 are oriented parallel to the magnetic field. In some examples, such as FIG. 2B, a scan line 202 may be less susceptible to a detrimental effect from interference because a scan line 202 may have a large magnitude (e.g., act as a binary signal) to activate the pixel circuit 200. As such, it may be an acceptable tradeoff to orient a scan line 202 non-parallel with respect to the magnetic field of an active coil 120 for design of a pixel circuit 200.

Often displays (e.g., OLED displays) may use a continuous cathode for a current return. The continuous cathode is a sheet of relatively thin metal on a layer below the active electronics of the display 140 (e.g., at the passivation layer 146). Here, the thin metal may be an actual metal sheet or a conductive material that has been deposited on a substrate to form a continuous cathode. For example, the passivation layer 146 includes a thin film conductor that functions as a transparent cathode (e.g., an ITO-based cathode). As a cathode, the continuous cathode may function as a ground plane for the pixel circuit 200. Yet unfortunately, a plane is inherently at an orientation that incurs an induced voltage from an active coil 120 (e.g., at some degree of an orthogonal orientation to the magnetic field) and thus, a ground plane inherently suffers from interference. To overcome this issue, the display 140 may use individual wires or conductive traces for cathodes instead of a continuous cathode sheet. For instance, the metal encapsulation layer of the passivation layer 146 is replaced with one or more individual wires that are arranged parallel to the magnetic field of the coil layer 120. Although it may be best to orient all individual ground wires parallel to the magnetic field of the coil layer 120, in some configurations, not all of the individual ground wires have a parallel orientation with the magnetic field. In some examples, the continuous cathode may be removed entirely such that the passivation layer 146 does not include a metal encapsulation layer (e.g., as shown in FIG. 2G).

FIG. 2C is an example of a pixel circuit 200. Here, the pixel circuit 200 includes the switch circuit 210 and the drive circuit 220. The pixel circuit 200 receives the scan signal 202 and the data signal 204 as inputs to activate at least one pixel associated with the pixel circuit 200. In some implementations, the pixel circuit 200 includes at least one transistor 230 that functions as a switch to activate or to deactivate a pixel associated with the pixel circuit 200. Referring to FIG. 2C, the pixel circuit 200 is shown as a two transistor 230 and one capacitor circuit (i.e., a 2T1C circuit). In this example, the switch circuit 210 includes a first transistor 230a and a second transistor 230b. For simplification, the scan signal 202 and the data signal 204 will be referred to as a high (1) and a low (0) where the high signal is configured to activate a transistor 230 allowing a charge to flow between the source (s) and the drain (d) while the low signal is configured to not activate the transistor 230. When the scan signal 202 is high, the signal activates the first transistor 230a (e.g., a switching transistor SW) such that a high data signal 204 may charge the capacitor until the capacitor charge activates the second transistor 230b (e.g., the driving transistor DR). When the second transistor is active 230, either the data signal 204 or another signal (e.g., a power signal such as a driving voltage Vdd from a voltage source) may function as a driving signal applied to a light-emitting diode 222 (e.g., OLED) of the drive circuit 220 to power the diode 222 and illuminate the pixel. For example, the controller 170 provides the power signal for the drive circuit 220. In some examples, the driving signal is configured to turn on the diode 222 (e.g., OLED) to an intensity/brightness less than full intensity (e.g., dimly illuminate a pixel of the display 140). Here, generally speaking, the drive circuit 220 is shown to include the diode 222 and configured to power the OLED 222 when the switch circuit 210 is active (e.g., the second transistor 230b is active). Accordingly, when at least one of the scan signal 202 or the data signal 204 is low, the drive circuit 220 is unable to power the diode 222 because the gate of the second transistor 230b is closed (e.g., in a cut-off mode).

In some configurations, a custom doping profile for a transistor 230 and/or diode 222 (e.g., an OLED) of a pixel circuit 200 reduces interference from an active coil 120 beneath the display 140. More particularly, both the transistor 230 and the diode 222 are semiconductor devices with a particular doping profile. The doping profile refers to a chemical composition of a semiconductor device that impacts and/or defines the electrical properties of the semiconductor device. The process of doping is a chemical process that introduces impurities into a semiconductor to generally modify the conductivity of the semiconductor. Here, by doping a semiconductor of a pixel circuit 200 with a particular doping profile, the semiconductor may be less susceptible to interference from an active coil 120. For example, if a threshold voltage for activation of a semiconductor is increased by doping, the increased threshold voltage is less likely to be affected by an induced voltage from an active coil 120. With regards to the pixel circuit 200, this means that a semiconductor of the pixel circuit 200 (e.g., a transistor 230 or an diode 222) may have a doping profile based on a magnetic field generated by a coil 120 of the coil layer 120. In some configurations, the diode 222 (e.g., the OLED) of the pixel circuit 200 is the only component of the pixel circuit 200 with a custom doping profile based on a magnetic field generated by a coil 120 of the coil layer 120. In other configurations, one or both of the switching transistor 230a and the drive transistor 230b have a custom doping profile based on a magnetic field generated by a coil 120 of the coil layer 120 while the diode 222 (e.g., the OLED) does not include a custom doping profile. In yet other configurations, both the transistor(s) 230 and the diode 222 include custom doping profiles. Here, each component may include unique doping profiles, the same doping profile, or some combination thereof.

In some configurations, the controller 170 is configured to overdrive the diode 222 (e.g., the OLED) to reduce visible interference in the display 140 during operation of the coil layer 120. In some examples, due to the interference from an active coil 120, a normal operating voltage applied to the diode 222 (e.g., the OLED) results in visible interference in the display 140. For example, the diode 222 (e.g., the OLED) does not actually illuminate at the pixel or the normal operating voltage causes the diode 222 to illuminate an incorrect amount of light (e.g., at a lower intensity). To overcome the deficiency caused by the interference, the controller 170 (e.g., through the data signal 204 or another power signal) supplies the diode 222 (e.g., the OLED) with a voltage that is greater than the operating voltage (e.g., greater than the operating voltage by some overdrive threshold voltage). Here, this overdriving technique causes super saturation of the pixel. This approach may be advantageous when a display 140 does not demand the subtleties of gradient coloration for one or more pixels. For example, a super saturation mode for the controller 170 is used when a display 140 generates simple color graphics (e.g., for indicator graphics). In some configurations, the controller 170 is configured to overdrive a selected group of pixels (e.g., adjacent pixels forming a block of pixels). Although grouping may alter the resolution of the display 140, overdriving a group of pixels may allow some relative degree of color variation. In other words, the size of the block of pixels forming the selected grouping of pixels may change based on the type of graphic being displayed by the display 140 or other configurable user/administrator settings.

In some implementations, the controller 170 is configured to interlace the induced voltage from an active coil 120 and the scan line signals to reduce interference for the display 140. In other words, when a coil 120 is active, there is an alternating magnetic field and an induced voltage from the magnetic field that is ninety degrees out of phase from the magnetic field. Therefore, there is a time during the cycle of the magnetic field where the induced voltage is zero (e.g., twice per cycle of the magnetic field). When the induced voltage goes to zero, the controller 170 latches the data into the display 140. Stated differently, the controller 170 is configured to activate the scan signal when the induced voltage from the magnetic field is zero. When the controller 170 activates the scan signal, voltage may transfer from the data line 204 into the switch circuit 220 (i.e., latching in the data). In some examples, the controller 170 is configured to identify or to receive a scan rate for the display 140. Based on the scan rate for the display 140, the controller 170 may phase lock the coil 120 such that the cycle of the magnetic field generated by the coil 120 synchronizes a particular phase of the magnetic field (e.g., when the induced voltage is zero) to the scan rate of the display 140.

Referring to FIG. 2D, the pixel circuit 200 may additionally include a filter 240 for one or more signals associated with a pixel circuit 200. In some examples, the filter 240 is a narrow band pass filter. Here, the filter 240 is configured to prevent a frequency or range of frequencies from passing through the filter 240. For example, FIG. 2D illustrates that the filter 240 is applied to the data signal on the data line 204. Here, the filter 240 is configured to permit a data signal frequency ranging from 0 Hz to the data rate (e.g., the maximum data rate for the display 140) while excluding frequencies greater than the data rate. In other words, if the magnetic resonating frequency of an active coil 120 is generally greater than the data rate, the filter 240 may be configured to filter the frequency of the active coil 120; preventing such an interfering frequency from passing into the pixel circuit 200 and causing potential display issues.

FIGS. 2E-2G are examples of signal modifications that may be made to the pixel circuit 200 to reduce interference on the scan line 202 and/or data line 204. FIG. 2E illustrates that, in some implementations, the controller 170 is configured to reduce interference (e.g., cross talk interference) between the scan signal of the scan line 202 and one or more adjacent coils 120 (e.g., an active coil). To reduce this scan signal interference, the controller 170 may split the scan signal (e.g., shown as SCAN) into complimentary signals, a SCAN′ and a SCAN,″ where SCAN″ is the inverted signal of SCAN′. Here, the controller 170 then differentially amplify the complimentary scan signals (e.g., with an analog summer) forming an amplified scan signal AMP SCAN. By adding the complimentary scan signals together, the in-phase induced voltages of these complimentary signals cancel; resulting in a clean scan signal without interference. Following this combination of complimentary scan signals, the amplified scan signal (e.g., clean scan signal) may be used with the data signal from the data line 204 to activate a pixel of a pixel circuit 200. For instance, FIG. 2E depicts an example logic configuration for the switch circuit 210 that then may be used to drive the diode 222 (e.g., the OLED) at the drive circuit 220.

FIG. 2F is a similar concept to FIG. 2E, but to reduce interference for a data signal on a data line 204. In this example, the controller 170 is configured to split the data signal DATA into complimentary signals, a DATA′ and a DATA″ where the DATA″ is the inverted signal of DATA′. Here, based on the switch circuit 210, the controller 170 latches in these complimentary data signals when a scan signal is active (e.g., high) on the scan line 202 (e.g., as down by the memory circuit blocks in FIG. 2F). Like FIG. 2E, the complimentary data signals DATA′ and DATA″ are then differentially amplified by the controller 170 (e.g., with an analog summer) to form an amplified data signal AMP DATA. By adding the complimentary data signals together, the in-phase induced voltages of these signals cancel; resulting in a clean data signal without interference. Following this combination of complimentary data signals, the amplified data signal (e.g., clean data signal) may be used with the scan signal from the scan line 202 to activate a pixel of a pixel circuit 200. For instance, FIG. 2F depicts an example logic configuration for the switch circuit 210 that then may be used to drive the OLED 222 at the drive circuit 220. Additionally, the concepts of FIGS. 2E and 2F may be combined such that the controller 170 splits and differentially amplifies each of the scan signal and data signal such that a switching circuit 210 has a clean scan signal and a clean data signal in order to enable power to be applied to the diode 222 (e.g., the OLED) at the drive circuit 220.

In some configurations, such as FIG. 2G, the complimentary signal approach (e.g., shown in FIG. 2F and/or combined with FIG. 2E) can replace a ground cathode or ground circuit associated with the pixel circuit 200. For instance, as shown in FIG. 2F, the diode 222 (e.g., the OLED) may be grounded in the drive circuit 220. Here, instead of grounding the drive circuit 220 at the diode 222, the inverted data signal DATA″ may function as a substitute for the ground signal. In this approach, the pixel circuit 200 may function as a non-grounded pixel circuit 200. By using this non-grounded approach, the pixel circuit 200 may avoid other forms of interference introduced by the ground signal (i.e., additional ground wires in the pixel circuit 200). Additionally, this approach, due to the complimentary signals, results in far-field cancelation such that electromagnetic emissions from the pixel circuit 200 are prevented and/or eliminated.

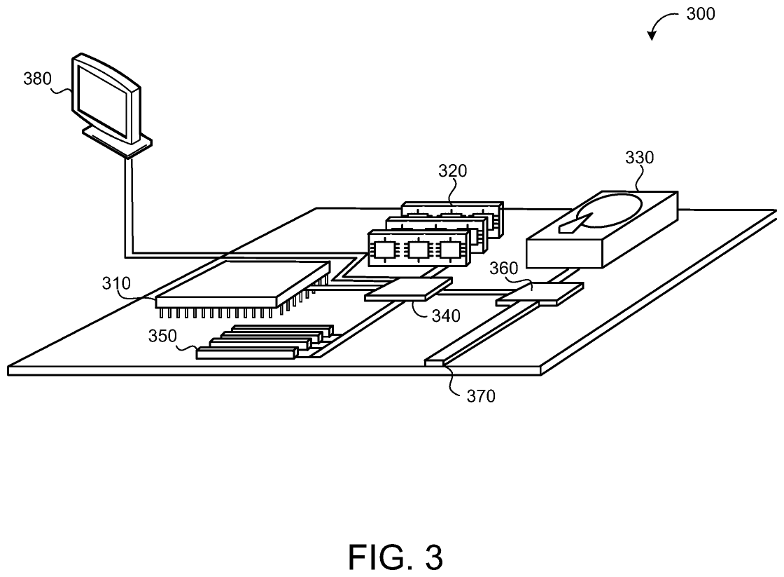

FIG. 3 is schematic view of an example computing device 300 that may be used to implement the systems (e.g., the inductive cooktop system 100, the display 140, the controller 170, etc.) and methods described in this document. The computing device 300 is intended to represent various forms of digital computers/processors, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 300 includes a processor 310 (e.g., data processing hardware), memory 320 (e.g., memory hardware), a storage device 330, a high-speed interface/controller 340 connecting to the memory 320 and high-speed expansion ports 350, and a low speed interface/controller 360 connecting to a low speed bus 370 and a storage device 330. Each of the components 310, 320, 330, 340, 350, and 360, are interconnected using various busses, and may be mounted on a common motherboard or in other manners as appropriate. The processor 310 can process instructions for execution within the computing device 300, including instructions stored in the memory 320 or on the storage device 330 to display graphical information for a graphical user interface (GUI) on an external input/output device, such as display 380 (e.g., the display 140) coupled to high speed interface 340. In other implementations, multiple processors and/or multiple buses may be used, as appropriate, along with multiple memories and types of memory. Also, multiple computing devices 300 may be connected, with each device providing portions of the necessary operations (e.g., as a server bank, a group of blade servers, or a multi-processor system).

The memory 320 stores information non-transitorily within the computing device 300. The memory 320 may be a computer-readable medium, a volatile memory unit(s), or non-volatile memory unit(s). The non-transitory memory 320 may be physical devices used to store programs (e.g., sequences of instructions) or data (e.g., program state information) on a temporary or permanent basis for use by the computing device 300. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 330 is capable of providing mass storage for the computing device 300. In some implementations, the storage device 330 is a computer-readable medium. In various different implementations, the storage device 330 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 320, the storage device 330, or memory on processor 310.

The high speed controller 340 manages bandwidth-intensive operations for the computing device 300, while the low speed controller 360 manages lower bandwidth-intensive operations. Such allocation of duties is exemplary only. In some implementations, the high-speed controller 340 is coupled to the memory 320, the display 380 (e.g., through a graphics processor or accelerator), and to the high-speed expansion ports 350, which may accept various expansion cards (not shown). In some implementations, the low-speed controller 360 is coupled to the storage device 330 and a low-speed expansion port 390. The low-speed expansion port 390, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device (e.g., the OLED display 140) or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

1. A system comprising:
an induction coil comprising a magnetic field; and
an electrically-actuated display (EAD) assembly disposed on the induction coil and comprising:
a frontplane adjacent to the induction coil; and
a thin film transistor (TFT) array backplane opposite the frontplane and comprising a scan line orthogonal to the magnetic field and a data line parallel to the magnetic field, the scan line and the data line configured to activate a display pixel corresponding to the EAD assembly, and
wherein one or more ground lines of the EAD assembly are arranged parallel to the magnetic field of the induction coil.

2. The system of claim 1, wherein the frontplane comprises a passivation layer encapsulating a portion of the EAD assembly, the passivation layer comprising at least one of the one or more ground lines of the EAD assembly.

3. The system of claim 1, wherein the frontplane does not include a metal encapsulation layer configured to function as a ground plane for the EAD assembly.

4. The system of claim 1, wherein all of the ground lines of the EAD assembly are arranged parallel to the magnetic field of the induction coil.

5. The system of claim 1, wherein the EAD assembly is disposed on and offset from the induction coil by an air gap.

6. The system of claim 1, wherein the induction coil comprises a C-shaped solenoid coil.

7. The system of claim 1, wherein EAD assembly comprises an organic light emitting diode (OLED).

8. A system comprising:
a switch circuit configured to activate a pixel for an electrically-actuated display (EAD);
a drive circuit comprising a light-emitting element (LEE), the drive circuit powering the LEE when the switch circuit activates the pixel; and
a controller controlling the switch circuit, the controller configured to perform operations comprising:
generating a scan signal and a data signal;
reducing crosstalk interference between the scan signal and an adjacent induction coil by:
splitting the scan signal into a first scan signal and a second scan signal, the second scan signal complimentary to the first scan signal;
differentially amplifying the first scan signal and the second scan signal to form an amplified scan signal; and
activating the pixel corresponding to the switch circuit using the amplified scan signal and the data signal.

9. The system of claim 8, wherein the operations further comprise:
reducing crosstalk interference between the data signal and the adjacent induction coil by splitting the data signal into a first data signal and a second data signal, the second data signal complimentary to the first data signal, and
wherein activating the pixel corresponding to the switch circuit uses the amplified scan signal, the first data signal, and the second data signal.

10. The system of claim 9, wherein the operations further comprise:
differentially amplifying the first data signal and the second data signal to form an amplified data signal, and
wherein activating the pixel corresponding to the switch circuit uses the amplified scan signal and the amplified data signal.

11. The system of claim 9, wherein the operations further comprise applying the second data signal to the drive circuit, the second data signal functioning as a ground for the drive circuit.

12. The system of claim 8, wherein the induction coil comprises a C-shaped solenoid coil.

13. The system of claim 8, wherein the LEE is an organic light emitting diode (OLED).

14. A system comprising:
a switch circuit configured to activate a pixel for an electrically-actuated display (EAD);
a drive circuit comprising a light-emitting element (LEE), the drive circuit powering the LEE when the switch circuit activates the pixel; and
a controller controlling the switch circuit, the controller configured to perform operations comprising:
generating a scan signal and a data signal;
reducing crosstalk interference between the data signal and an adjacent induction coil by splitting the data signal into a first data signal and a second data signal, the second data signal complimentary to the first data signal; and
activating the pixel corresponding to the switch circuit using the first data signal, the second data signal, and the scan signal.

15. The system of claim 14, wherein the operations further comprise:
differentially amplifying the first data signal and the second data signal to form an amplified data signal, and
wherein activating the pixel corresponding to the switch circuit uses the scan signal and the amplified data signal.

16. The system of claim 14, wherein the operations further comprise applying the second data signal to the drive circuit, the second data signal functioning as a ground for the drive circuit.

17. The system of claim 14, wherein the induction coil comprises a C-shaped solenoid coil.

18. The system of claim 14, wherein the LEE is an organic light emitting diode (OLED).

19-40. (canceled)
